(19) United States
(12) Patent Application Publication
(10) Pub. No.: US 2010/0299426 A1
(43) Pub. Date: Nov. 25, 2010

(54) SERVICE-ORIENTED ARCHITECTURE

(75) Inventors: Michael McGrady, Tacoma, WA (US); Michael R. Manzano, Seattle, WA (US)

Correspondence Address: BLACK LOWE & GRAHAM, PLLC, 701 FIFTH AVENUE, SUITE 4800, SEATTLE, WA, 98104, US

(73) Assignee: TOPIA TECHNOLOGY, Tacoma, WA (US)

(21) Appl. No.: 12/784,885

(22) Filed: May 21, 2010

Related U.S. Application Data
(60) Provisional application No. 61/180,386, filed on May 21, 2009.

(51) Int. Cl. G06F 15/173

(52) U.S. Cl. 709/223

(57) ABSTRACT

A Service-Oriented Architecture (SOA) Communication Model (CM) allows a service producer to seek out service consumer types and to send them information. The consumer, actively or passively, is also configured to “advertise.” The information that is advertised could come (passively) from information already in a system, such as an application architecture, comprising the roles and attributes in a consumer's security certificate(s). The information could come (actively) from a registry of users with a system-user ontology that is created especially for this purpose and otherwise is not already in the system. This approach will allow a producer to initiate sending information to a consumer.

### CROSS-REFERENCE TO RELATED APPLICATIONS

This application claims priority to U.S. Provisional Appl. No. 61/180,386 entitled “PUSH MODEL FOR INFORMATION ACQUISITION OVER A NETWORK” and filed May 21, 2009, which is hereby incorporated by reference in its entirety.

### BACKGROUND OF THE INVENTION

A fundamental decision in the architecture of networked computer systems is whether or not the network integration logic between computers is decoupled from the application (domain) logic. Networking architectures generally are loosely organized by how much and what is decoupled from the application logic of monolithic system architectures of the past.

### BRIEF DESCRIPTION OF THE DRAWING

Preferred and alternative embodiments of the present invention are described in detail below with reference to the following drawings.

FIG. 1 is a functional block diagram of an exemplary operating environment in which an embodiment of the invention can be implemented;

FIG. 2 illustrates a communication model according to an embodiment;

FIG. 3 illustrates a communication model according to an embodiment;

FIG. 4 illustrates a communication model according to an embodiment; and

FIG. 5 illustrates a communication model according to an embodiment.

### DETAILED DESCRIPTION OF THE PREFERRED EMBODIMENT

Embodiments of the invention are operational with numerous general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Embodiments of the invention may be described in the general context of computer-executable instructions, such as program modules, being executed by a computer and/or by computer-readable media on which such instructions or modules can be stored. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

Embodiments of the invention may include or be implemented in a variety of computer readable media. Computer readable media can be any available media that can be accessed by a computer and includes both volatile and nonvolatile media, removable and non-removable media. By way of example, and not limitation, computer readable media may comprise computer storage media and communication media. Computer storage media include volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

According to one or more embodiments, the combination of software or computer-executable instructions with a computer-readable medium results in the creation of a machine or apparatus. Similarly, the execution of software or computer-executable instructions by a processing device results in the creation of a machine or apparatus, which may be distinguishable from the processing device, itself, according to an embodiment.

Correspondingly, it is to be understood that a computer-readable medium is transformed by storing software or computer-executable instructions thereon. Likewise, a processing device is transformed in the course of executing software or computer-executable instructions. Additionally, it is to be understood that a first set of data input to a processing device during, or otherwise in association with, the execution of software or computer-executable instructions by the processing device is transformed into a second set of data as a consequence of such execution. This second data set may subsequently be stored, displayed, or otherwise communicated. Such transformation, alluded to in each of the above examples, may be a consequence of, or otherwise involve, the physical alteration of portions of a computer-readable medium. Such transformation, alluded to in each of the above examples, may also be a consequence of, or otherwise involve, the physical alteration of, for example, the states of registers and/or counters associated with a processing device during execution of software or computer-executable instructions by the processing device.

An embodiment of the invention leverages remote programming concepts by utilizing processes called mobile agents (sometimes referred to as mobile objects or agent objects). Generally speaking, these concepts provide the ability for an object (the mobile agent object) existing on a first (“host”) computer system to transplant itself to a second (“remote host”) computer system while preserving its current execution state. The operation of a mobile agent object is described briefly below.

The instructions of the mobile agent object, its preserved execution state, and other objects owned by the mobile agent object are packaged, or “encoded,” to generate a string of data that is configured so that the string of data can be transported by all standard means of communication over a computer network. Once transported to the remote host, the string of data is decoded to generate a computer process, still called the mobile agent object, within the remote host system. The decoded mobile agent object includes those objects encoded as described above and remains in its preserved execution state. The remote host computer system resumes execution of the mobile agent object which is now operating in the remote host environment.

While now operating in the new environment, the instructions of the mobile agent object are executed by the remote host to perform operations of any complexity, including defining, creating, and manipulating data objects and interacting with other remote host computer objects.

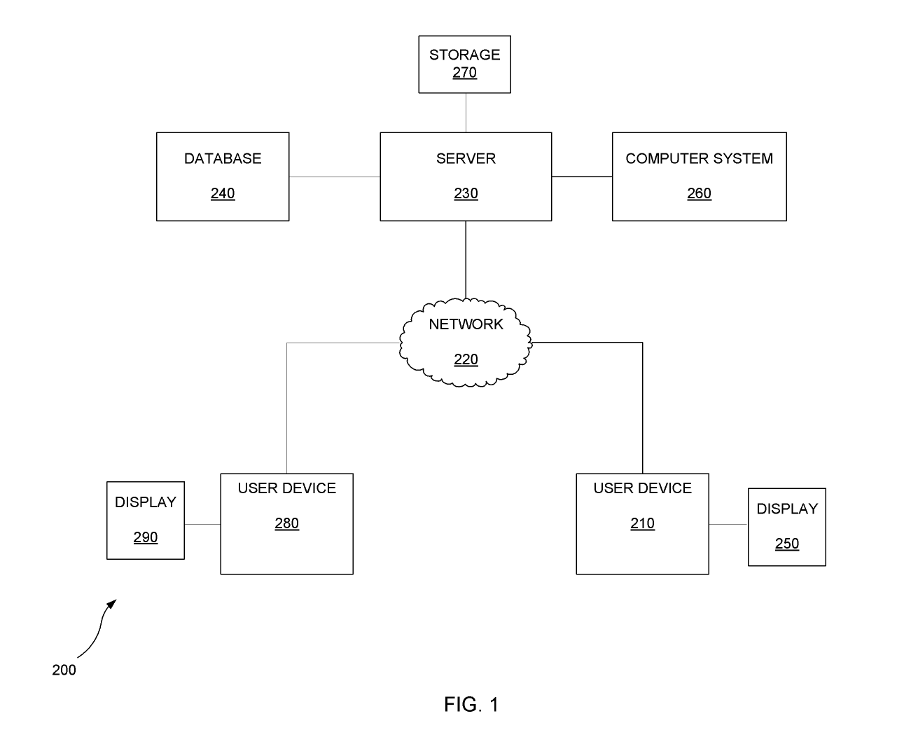

Referring now to FIG. 1, an embodiment of the present invention can be described in the context of an exemplary computer network system 200 as illustrated. System 200 includes representative electronic user devices 210, 280, such as personal computers or workstations, or a set of enterprise computing devices, that are linked via a communication medium, such as a network 220 (e.g., the Internet), to an electronic device or system, such as a server 230. The server 230 may further be coupled, or otherwise have access, to a database 240, electronic storage 270 and a computer system 260. Although the embodiment illustrated in FIG. 1 includes one server 230 coupled to two user devices 210, 280 via the network 220, it should be recognized that embodiments of the invention may be implemented using two or more such user devices coupled to one or more such servers, or possibly to no such server.

User devices 210, 280 may include or be otherwise coupled to a computer screen or display 250, 290, respectively. User devices 210, 280 can be used for various purposes including both network- and local-computing processes.

The user devices 210, 280 may be linked via the network 220 to server 230 so that computer programs, such as, for example, a browser or other applications, running on the user devices 210, 280 can cooperate in two-way communication with server 230. Server 230 may be coupled to database 240 and/or electronic storage 270 to retrieve information therefrom and to store information thereto. Additionally, the server 230 may be coupled to the computer system 260 in a manner allowing the server to delegate certain processing functions to the computer system.

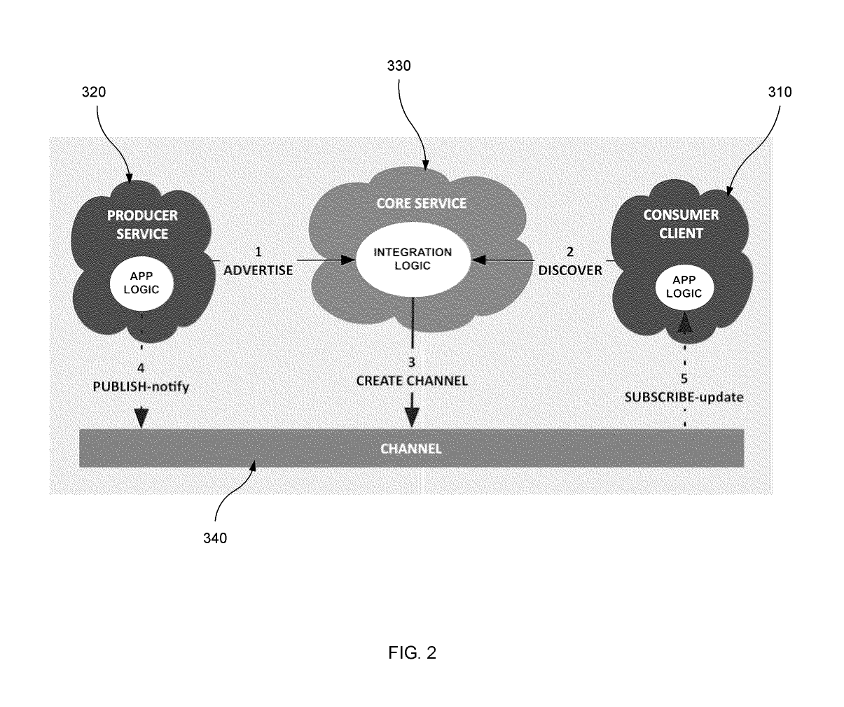

Referring now to FIG. 2, a basic Service-Oriented Architecture (SOA) Communication Model (CM) according to an embodiment is illustrated. The CM allows communication between a consumer 310, such as an application architecture, and a producer 320, such as a component architecture, based on the information that each provides to Core Services (CS) element 330, such as a service architecture. When the consumer 310 “subscribes” to the producer service, a channel 340 is created between the producer 320 and the consumer, but neither is aware that this is happening, since the integration logic is decoupled from the application logic.

The CM models magazine publishing and, hence, the “advertise”, “publish”, and so on terminology: (1) a producer makes information (magazine) available; (2) a consumer discovers the information (magazine) availability and passes along subscription information to the parent company; (3) the company sets up a delivery mechanism; (4) information (magazine) is published and the delivery mechanism is notified; and (5) the consumer receives the updated information (magazine) in the mailbox. The model sometimes is denominated “Pub-Sub,” the “Pub-Sub Communication Model” or “PSCM”, here. The delivery mechanism (channel) is created when the consumer subscribes to the information.

The semantics of the PSCM is not nearly as diverse as the semantics of communications generally. For example, in a real-life magazine publishing company, extensive information is kept about the consumer and the company has the option to send suggestions about new or old magazines directly to the consumer. In information technology (IT), a host of wrappers are created around the PSCM that allow it to mimic these behaviors. An embodiment provides network technology that allows consumers and producers to directly participate in the diversity of communication semantics without wrappers and kludges. Basic Smart Information (BSI), Intermediate Smart Information (ISI) and Advanced Smart Information (ASI) provide differing technologies that work together.

Basic Smart Information Communication Model (BSICM))

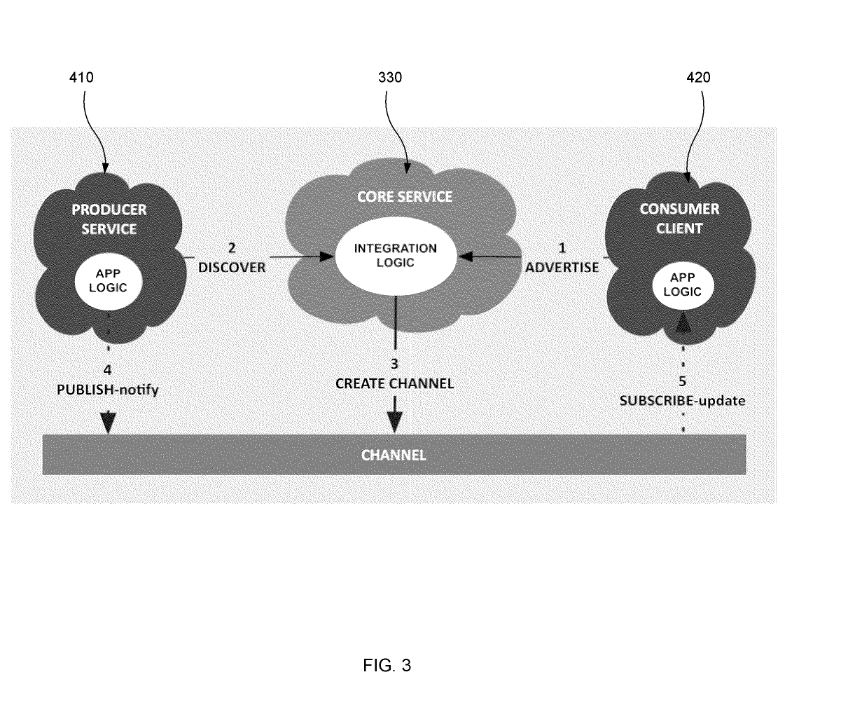

Referring now to FIG. 3, an embodiment, at the most basic, i.e., BSICM, level allows a producer 410, such as a component architecture, to seek out consumer 420 types, such as an application architecture, and to send them information. There is no mechanism in the PSCM that allows the system to model these semantics. The optionally advantageous feature of the BSICM that enables this is that the consumer 420, actively or passively, is also allowed to “advertise.” The consumer 420, for example, could advertise that it belongs to a virtual sheriff of Macon County, GA. The information that is advertised could come (passively) from information already in the system, such as the application architecture, comprising the roles and attributes in a consumer's security certificate(s). Or, the information could come (actively) from a registry of users with a system-user ontology that is created especially for this purpose and otherwise is not already in the system. Various mechanisms could be used, but the point is that they are not already there and this change will allow a producer 410 to initiate sending information to a consumer 420.

The power that the BSICM creates is huge. A producer 410 knows, on occasion, information that types of users need and the users (consumers 420) do not know this. Warnings and alerts are semantically coincident with BSICM. Consumers 420 can, of course, subscribe to warnings and alerts that they expect, but that is not what the illustrated embodiment considers here. That is covered in the PSCM. The warnings and alerts that discussed with reference to the illustrated embodiment are the dangers, unexpected turns of events, and so on, that we do not know about and would be over-planning to expect. There are, for example, any number of alerts, warnings, and so on, that a Sheriff in Macon County, GA, would want to know about but cannot possibly plan (subscribe) to in the ordinary course of business. Users generally are in this position. Even if they could plan for alerts, etc., this would be inefficient. Holders of the information generally, but not always, are in a far better position to assess the need of a potential information consumer.

As illustrated in FIG. 3, (1) a consumer advertises some characteristic describing itself; (2) a producer discovers the advertised consumer and passes along service information to the service architecture 330; (3) the service architecture 330 sets up a delivery mechanism/channel; (4) the service is published and the delivery mechanism/channel is notified; and (5) the consumer receives the updated/subscribed-to service.

Intermediate Smart Information Communication Model (ISICM)

The consumer 420 in a BSICM system not only can subscribe to information but also can be available to be subscribed to information. The semantics of the information is one of a unidirectional information flow from a given entity (a producer 410) to another given entity (a consumer 420). In no event does information flow from a consumer 420 to a producer 410. And, this is as it should be, since producers 410 are producers of information and consumers 420 are consumers of information and the direction of the flow is not a matter of choice.

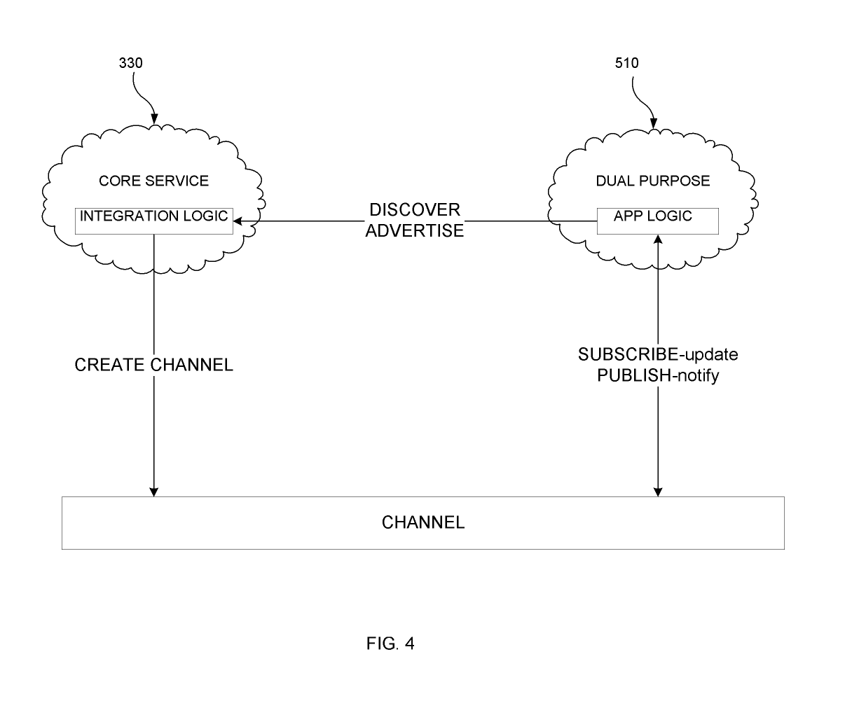

Referring now to FIG. 4, however, a given entity in a system can act as both a producer and a consumer of information, and this too represents a normal semantic for information exchange. The intermediate level of an embodiment, ISICM, creates a “producer-consumer” entity 510 on the system with dual BSICM options.

The intermediate version of a module of an embodiment steps out of the traditional event-channel consumer/producer dichotomy. With the basic embodiment, as illustrated in FIG. 3, consumers can act as producer and producers as consumers. This is not especially advantageous except when the dual entities communicate with other dual entities.

In the embodiment illustrated in FIG. 4, the basic semantics of communication undergo a qualitative difference. Consumers can not only receive information both by an initiation on their part but on an initiation of a producer's part, but can send information with a request and send information at their own behest. Thus, the semantics of information come full circle and can be modeled in the myriad of possible semantic features of communicators, e.g. publisher, gossip, speaker, snoop, and so on, and their communications. Now every type of communication semantics can be envisioned in the system.

Advanced Smart Information Communication Model (ASICM)

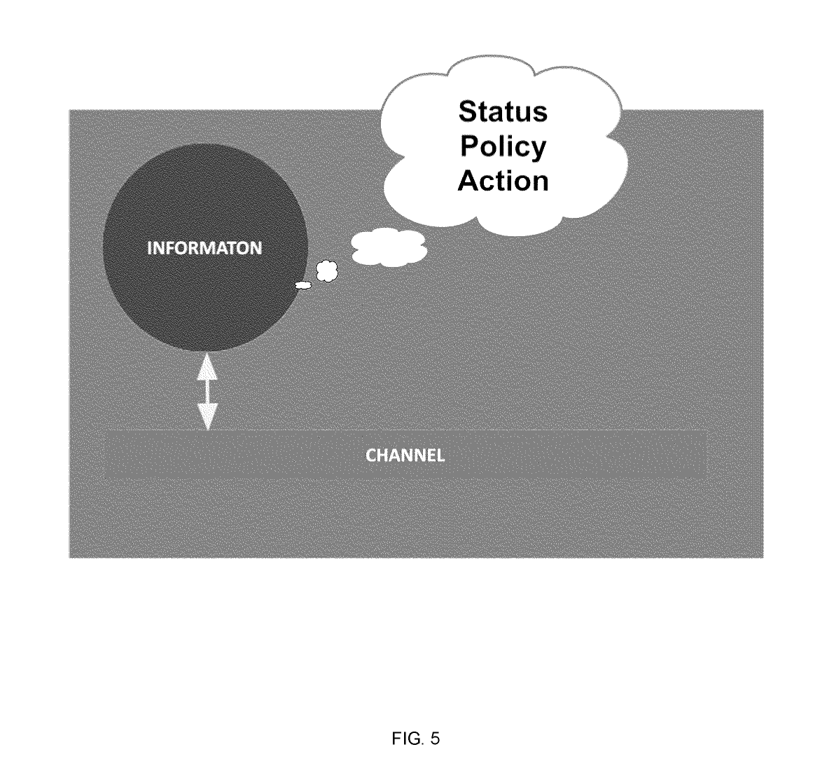

The discussed basic embodiment involved the flow of information remaining the same but the initiation of the creation of the channel changing from the consumer to the producer and the concomitant requirement that the consumer advertise and the producer subscribe. Intermediate Smart Information involved the change in the flow of information both to and from a consumer/producer. When coupled in a network with other consumer/producer entities, all the semantics of communication models could be evidenced. The embodiment illustrated in FIG. 5 moves outside the normal world of communication semantics and into a basic paradigm shift involving the structure and exchange of information to a truly net-centric (getting the right information to the right person at the right time) environment. The Advanced Smart Information Communication Model (ASICM) involves information itself acting as a consumer/producer in terms of the ISICM. Information may be wrapped in metadata and functionality that makes it both a consumer and a producer of information, policies, etc.

Information in a messaging system normally is thought of as “dead” in the sense that it needs to be digested and that is all that it requires. Information in ASICM on the other hand is “alive” and takes an active part in its lifecycle as both a producer and a consumer. This involves a conceptual shift because it is a new phenomenon in the world. Information in ASICM has a status, has policies involving itself and others, and is capable of taking action (tattling, complaining, looking out of its own interest, etc.).

As such, the ASICM may require that its information be bundled, wrapped, and so on, with functionality, and that architectures (mobile object systems, distributed associative memory systems, and so on) be consistent with this requirement. An example would be an item of inventory. The item of inventory, further, might be an airplane part. A repository of the part would be responsible for keeping the status of the part. For example, the part might have to be checked at three-month intervals. The part could also include policies. If the part was not checked at the appropriate interval or checked at the wrong interval, a policy to notify an individual could be instituted. Additionally, if the part turned up at a wrong location, the part could take another action. For example, a part could refuse to deserialize itself and be read as information until the reader passed the part a password.

While a preferred embodiment of the invention has been illustrated and described, as noted above, many changes can be made without departing from the spirit and scope of the invention. Instead, the invention should be determined entirely by reference to the claims that follow.

The embodiments of the invention in which an exclusive property or privilege is claimed are defined as follows:

1. A system, comprising:
a consumer to advertise at least one characteristic of the consumer; and
a producer to subscribe in order for a producer to be able to initiate the creation of an event-channel by a core services element, and provide a service to the consumer based on the at least one characteristic.
